(19) United States
(12) Patent Application Publication
(10) Pub. No.: US 2011/0177356 A1
(43) Pub. Date: Jul. 21, 2011

(54) METHOD FOR PREPARING Pt THIN FILMS USING ELECTROSPRAY DEPOSITION AND Pt THIN FILMS FORMED BY THE METHOD

(75) Inventors: Oh Shim Joo, Seoul (KR); Kwang Deog Jung, Seoul (KR); Jyotiprakash B. Yadav, Seoul (KR)

(73) Assignee: Korea Institute of Science and Technology, Seoul (KR)

(21) Appl. No.: 12/849,125

(22) Filed: Aug. 3, 2010

(30) Foreign Application Priority Data
Jan. 21, 2010 (KR) 10-2010-0005486

(51) Int. Cl. B32B 15/01; B05D 1/04

(52) U.S. Cl. 428/548; 427/458; 428/670

(57) ABSTRACT

The present invention relates to a method for preparing Pt thin films using electrospray deposition, more specifically a method for preparing platinum thin film using electrospray deposition, including dissolving a platinum (Pt) precursor in ethanol to prepare a precursor solution for spraying (Step 1); applying a DC voltage between a substrate holder and a nozzle of an electrospraying device and then spraying the precursor solution prepared in Step 1 on a substrate which is maintained at about 100° C. to about 180° C. to form a platinum thin film (Step 2); and subjecting the platinum thin film formed in Step 2 to a heat treatment (Step 3). According to the present invention, the thickness of the platinum thin film may be easily regulated by controlling the amount of a precursor solution sprayed, and the platinum thin film may be continuously prepared on a substrate which has a wide area, therefore a highly active platinum thin film may be obtained by using a small amount of platinum which is expensive, and the film may be usefully used as an Pt electrode used a stable cathode electrode for a process which converts the photo energy into electric or chemical energy, or for a wastewater treatment system or a water purification system.

### CROSS-REFERENCES TO RELATED APPLICATION

This patent application claims the benefit of priority from Korean Patent Application No. 10-2010-05486 filed on Jan. 21, 2010, the contents of which are incorporated herein by reference.

### BACKGROUND OF THE INVENTION

1. Field of the Invention

The present disclosure relates to a method for preparing Pt thin films using electrospray deposition, which is applicable to a wide area of a metal substrate and may control the amount of Pt freely, and the Pt thin films formed by the method.

2. Description of the Related Art

Because Platinum is highly electrochemically active, bio-friendly, and highly stable even in electrolyte such as strong acid or strong base, etc., the metal is used as a counter electrode for a photoelectrochemical cell or a cathode in various cell systems such as alkaline electrolysis, sea water electrolysis, wastewater treatment apparatus, etc. However, platinum is an expensive metal. Therefore, the technology, with which thin film is prepared by applying a small amount of platinum uniformly on a metal substrate in which electrons can transfer freely, is required in order to achieve the same objective without using a large amount of the metal.

In order to form Pt films on a substrate, sputtering (Korean Patent No. 10-0321694 and JP No. 1994-091264), electrodeposition (U.S. Pat. No. 5,529,680, U.S. Pat. No. 4,552,641, U.S. Pat. No. 6,136,704, US 2007/0092786 A1, Mater. Chem. & Phys. 85 (2004) 396, J. Magnetism and magnetic Mat. 320 (2008) 2985, Catalysis commun. 10 (2009) 610, Electrochimica Acta, 46 (2000) 661, Int. J. Hydro. Energy, 33 (2008) 5672), brushing (Korean Patent No. 10-0383269), CVD (U.S. Pat. No. 6,750,110 B1 & U.S. Pat. No. 7,157,114 B2), plasma polymerization (U.S. Pat. No. 6,426,126 B1), etc. are used. However, the methods require additional pre-treatment processes and expensive equipment in order to increase the adhesive force between substrate and M platinum and have difficulties in preparing a uniform and wide surface of Platinum film. Conversely, the deposition of platinum thin film using electrospray method allows for the utilization of simple and inexpensive devices, easy regulation of the amount of deposition, continuous process, fast deposition rate, and high-efficient preparation of platinum thin film which may replace expensive platinum currently used in the industrial process by using a minimum amount of solution.

Thus, the present inventors have studied a method for forming platinum thin films which has a large surface on a metal substrate by using a small amount of platinum without additional pre-treatment processes and completed the present invention.

### SUMMARY OF THE INVENTION

One object of the present invention is to provide a method for preparing platinum thin films on a substrate by a simple electrospray method and platinum thin films prepared by the method.

In order to achieve the objects, the present invention provides a method for preparing platinum thin film using electrospray deposition, including: dissolving a platinum (Pt) precursor in ethanol to prepare a precursor solution for spraying; applying a DC voltage between a substrate holder and a nozzle of an electrospraying device and then spraying the precursor solution prepared in step on a substrate which is maintained at about 100° C. to about 180° C. to form a platinum thin film; and subjecting the platinum thin film formed in the step to a heat treatment.

The present invention also provides platinum thin films prepared by the preparation method.

According to the present invention, a platinum thin film may be formed on a substrate by a simple and efficient electrospraying without additional pre-treatment processes, the thickness of the platinum thin film may be easily regulated by controlling the amount of a precursor solution sprayed, and the platinum thin film may be continuously prepared on a substrate which has a wide area. Therefore, a highly active platinum thin film may be obtained by using a small amount of platinum which is expensive. Because a platinum thin film prepared by the method of the present invention is highly photoactive and stable, the film may be usefully used as a stable cathode electrode for a process which converts the photo energy into electric or chemical energy, or for a wastewater treatment system or a water purification system.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view illustrating an electrospraying device, by which platinum thin films in the present invention are prepared;

FIG. 2 is a SEM image illustrating a platinum thin film prepared on a Ni plate using the device in FIG. 1 according to one example of the present invention;

FIG. 3 is an EDX spectrum illustrating a platinum thin film prepared according to one example of the present invention;

FIG. 4 is an XPS spectrum illustrating a platinum thin film prepared according to one example of the present invention; and

FIG. 5 is a graph illustrating each of the amounts of hydrogen produced by using a platinum thin film prepared according to one example of the present invention, a pure Pt mesh, and a Ni plate as a cathode, respectively.

### DESCRIPTION OF THE PREFERRED EMBODIMENTS

Features and advantages of the present invention will be more clearly understood by the following detailed description of the present preferred embodiments by reference to the accompanying drawings. It is first noted that terms or words used herein should be construed as meanings or concepts corresponding with the technical spirit of the present invention, based on the principle that the inventor can appropriately define the concepts of the terms to best describe his own invention. Also, it should be understood that detailed descriptions of well-known functions and structures related to the present invention will be omitted so as not to unnecessarily obscure the important point of the present invention.

The present invention provides a method for preparing platinum thin films using electrospray method, including:

dissolving a platinum (Pt) precursor in ethanol to prepare a precursor solution for spraying (Step 1);

applying a DC voltage between a substrate holder and a nozzle of an electrospraying device and then spraying the precursor solution prepared in Step 1 on a substrate which is maintained at about 100° C. to about 180° C. to form a platinum thin film (Step 2); and

subjecting the platinum thin film formed in Step 2 to a heat treatment (Step 3).

Hereinafter, the present invention will be described in detail with reference to each step.

The Step 1 according to the present invention is a step in which a platinum (Pt) precursor solution is dissolved in ethanol to prepare a precursor solution for spraying. A platinum precursor which is used to prepare a platinum thin film in the present invention is preferably one selected from the group consisting of K₂PtCl₆, hydrogen hexachloroplatinate (IV) (H₂PtCl₆), hydrogen hexachloroplatinate (IV) hydrate (H₂PtCl₆.x(H₂O)) platinum (II) acetylacetonate (C₁₀H₁₄O₄Pt), and tetraamineplatinum (II) nitrate (H₁₂N₆O₆Pt). Because the platinum precursors are commercially available and easy to buy, they are suitable for use in the present invention, and in particular, H₂PtCl₆ and H₂PtCl₆.x(H₂O) are the most preferred due to their relatively low prices. It may be confirmed through XPS that the chlorine (Cl) component is not present in a platinum thin film prepared by using a Cl compound. A precursor solution is preferably prepared by dissolving a platinum (Pt) salt in the range of about 0.005 M to about 0.015 M in a solvent such as water, acetone, methanol, ethanol, isopropyl alcohol (IPA), etc., or a mixed solution containing water and organic solvents. When the concentration of the precursor is less than 0.005 M, a platinum thin film may be deposited. However, it takes too long for the deposition and a sufficient platinum thin film may not be formed on a substrate. When the concentration is more than 0.015 M, it is difficult to form a platinum thin film which is sufficiently thin and uniform. Furthermore, expensive platinum may be excessively consumed.

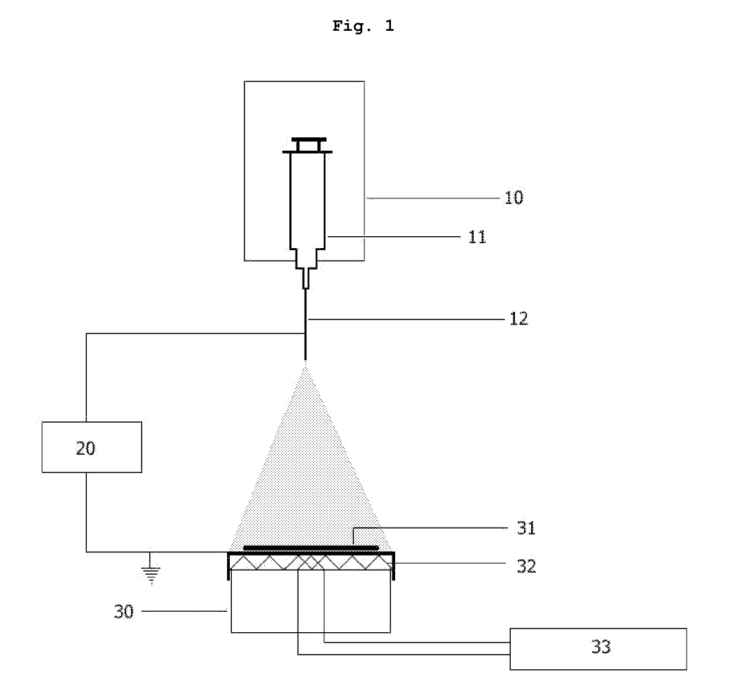

The Step 2 according to the present invention is a step in which the precursor solution prepared in Step 1 is sprayed through a nozzle on the substrate by using an electrospraying device to form a platinum thin film. More specifically, the Step 2 is a step in which a metal substrate (31) is placed on a heating plate (32) in FIG. 1, a substrate holder (30) is maintained at a constant temperature, a DC voltage of kV is applied between a nozzle (12) and a substrate (31) in FIG. 1, and then the precursor solution prepared in Step 1 is sprayed at a constant rate on the surface of the substrate by using a syringe pump (11).

An electrospraying device used in the present invention is shown in FIG. 1 and includes a syringe pump (11) (a 10 cc plastic syringe) and a metal nozzle (12) with a diameter of 0.2 mm. The substrate holder (30) may be heated to about 180° C., is formed of stainless steel with a size of 30×30 Cm², includes a DC voltage supply device by which a voltage of 0 to about 60 kV may be applied, and continuously prepares a film with a wide surface area by using a mounted robot which may control the moving distance along the x-y axis. Because the device may control the amount of the solution sprayed to regulate the thickness of the platinum thin film, a highly active platinum thin film may be obtained by using only a small amount of platinum.

A metal substrate used in the present invention is preferably a substrate which has a high electrical conductivity and is not reactive with electrolytes. Specifically, the substrate is preferably one selected from the group consisting of nickel (Ni), stainless steel (SS), titanium (Ti), copper (Cu), aluminum (Al), molybdenum (Mo), cadmium (Cd), gold, and carbon. Nickel or stainless steel is the most preferred metal due to its relatively low price.

When a platinum thin film is coated on a metal substrate, the amount of a platinum (Pt) precursor solution is preferably about 2 Ml to about 5 Ml and the rate of spraying the solution is preferably about 10 μl/min to about 25 μl/min. When the amount of the precursor solution sprayed is less than 2 Ml, a uniform platinum thin film may not be obtained because the amount of the solution sprayed is not sufficient compared to the area of the substrate. When the amount is more than 5 Ml, the loss of platinum may occur because the solution is used more than necessary. When the rate of spraying the solution is less than 10 μl/min, the nozzle may be clogged. When the rate is more than 25 μl/min, it is difficult to obtain a uniform platinum thin film and cracks on the surface of the platinum thin film may be produced. A voltage applied between a nozzle and a metal substrate is preferably about 10 kV to about 18 kV. When the voltage is less than 10 kV, it is so difficult to disperse the particles of the solution that it is difficult to obtain a uniform thin film and big cracks may be produced on the surface of the thin film because big particles of the solution contact the substrate. When the voltage is more than 18 kV, the angle at which the solution is sprayed increases, decreasing the efficiency of deposition and increasing the loss of the platinum solution. The substrate holder may be maintained at about 100° C. to about 180° C. according to the properties of a solvent used. When the temperature is less than 100° C., a film which has weak adhesion may be produced because it is difficult to decompose the metal precursor sufficiently. When the temperature is more than 180° C., the rate of decomposing the metal precursor is so fast that it may be difficult to obtain a uniform thin film.

The Step 3 according to the present invention is a step in which the platinum thin film formed in Step 2 is heated in a furnace in the range of about 350° C. to about 450° C. for about 1 to about 3 hours. In the step, a precursor salt which is still remaining due to insufficient decomposition during the spraying in Step 2 may be completely decomposed to obtain a desired platinum thin film.

In this way, a highly reactive and stable platinum thin film with a wide surface area may be continuously prepared.

The present invention also provides a platinum thin film on a substrate prepared by the method.

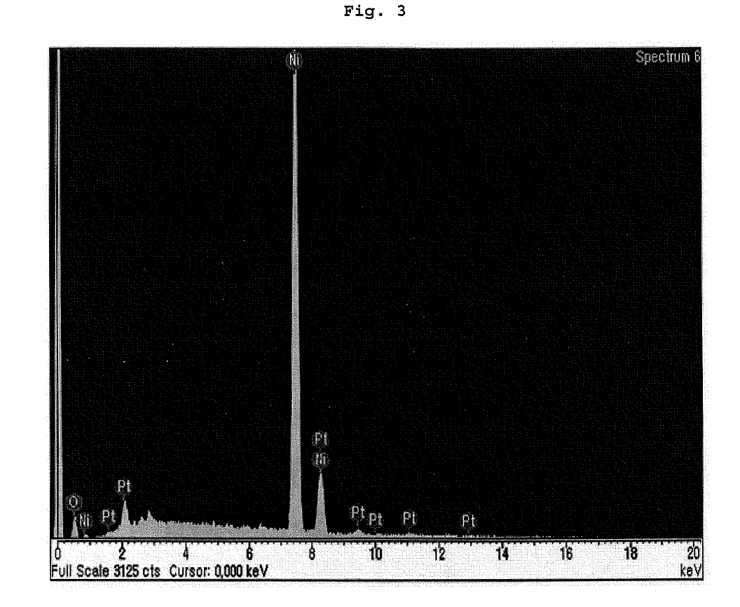

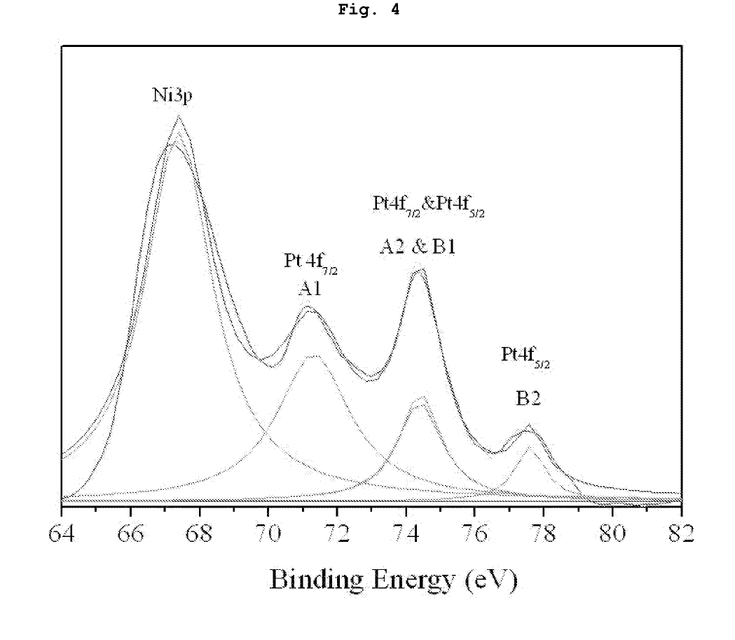

A platinum thin film prepared by the present invention contains platinum in the oxidation state on the surface of the thin film after subjecting to the heat treatment in Step 3 of the preparation method. It may be understood through the EDX spectrum in FIG. 3 and the XPS spectrum in FIG. 4 that the platinum thin film contains a platinum oxide besides pure platinum on the substrate. It is thought that some oxygen included on the surface of the Pt thin film improves the adhesion with nickel, enhancing the stability in the aqueous solution.

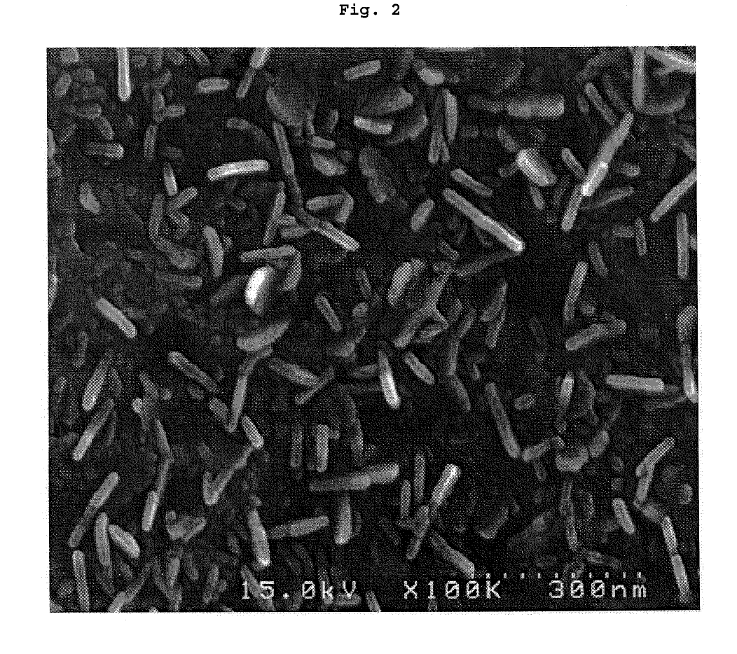

Furthermore, the platinum in the platinum thin film prepared according to the present invention has a planar structure in which the horizontal length is greater than the vertical length, and it is vertically arranged on the surface of the substrate. It may be confirmed through the following scanning electron microscope (SEM) photo in FIG. 2. The structure and arrangement direction as described above allows the platinum to be more active than a Pt mesh that has a smooth surface.

It may be understood through a scanning electron microscope (SEM) photo in FIG. 2 that the thickness of the platinum thin film prepared according to the present invention is about 300 Å to about 400 Å and the diameters of the particles are 100 nm or less. Because a small amount of platinum may be used to form a platinum thin film and the microcrystal structure in which the diameters of the particles are small allows the electrical current to be increased as the surface area is increased, the platinum thin film may increase the production of hydrogen when it is used as a counter electrode for a photoelectrochemical cell.

Hereinafter, the present invention will be described in detail with reference to examples and experimental examples. However, the following examples and experimental examples are provided to illustrate the present invention, and the scope of the present invention is not limited thereto.

### Example 1

The Preparation of a Platinum Thin Film on a Ni Plate Substrate

Hydrogen hexachloroplatinate (IV) hydrate (H₂PtCl₆.x(H₂O)) as a platinum precursor was electrosprayed on a Ni plate (90 mm×90 mm) substrate by using a conventional electrospraying device to obtain a platinum thin film, and the experimental conditions are summarized in the following Table 1.

TABLE 1

| | |
|---|---|
| Concentration of a precursor | 10 mM H₂PtCl₆•xH₂O in EtOH |
| solution | |
| Volume of a precursor solution | 3 ml |
| Rate of spraying a precursor | 10 μl/min |
| solution | |
| Type of a substrate | Ni plate (90 mm × 90 mm) |
| Temperature of a substrate | 180 □ |
| Voltage applied | 14 kV |

First, H₂PtCl₆.xH₂O at 10 mM was measured, put into a beaker containing ethanol, and dissolved in ethanol while stirring to prepare a platinum precursor solution for spraying. 3 Ml of the precursor solution prepared above was placed into a syringe pump which was connected to a nozzle of an electrospraying device, a voltage of 14 kV was applied between a substrate holder and the nozzle, and then the solution was sprayed on a Ni plate substrate which had a surface area of 8,100 mm² and was maintained at about 180° C. at the rate of 10 μl/min. A film formed after all of the solution was sprayed was subjected to a heat treatment in an electrical furnace which had been heated to about 400° C. for 2 hours to increase the adhesion of a platinum thin film on Ni substrate. The amount of platinum included in 3 Ml of the precursor solution was 5.582×10⁻³ g, and the concentration of platinum in the platinum thin film was 7.22×10⁻⁵ g/cm² when all of the platinum was sprayed on the substrate.

### Experimental Example 1

Analysis of Surface Morphology of a Platinum Thin Film

The surface of the platinum thin film prepared in Example 1 was observed by a scanning electron microscope (SEM: Hitachi-S4100 model) and the image was illustrated in FIG. 2. The surface was composed of platinum having a planar structure in which the horizontal length was greater than the vertical length, and a surface morphology which was largely arranged in the vertical direction on the surface of the Ni plate was observed. Furthermore, it may be understood that the thickness of the uniform film obtained after the heat treatment was about 340 Å and the particle diameters of platinum in the film were about 50 nm to about 150 nm (the diameters of the particles vertically grown were about 150 nm). Because the surface area of the platinum thin film was increased by the surface morphology, platinum as a counter electrode for a photoelectrochemical cell may increase the electrical current to increase the amount of hydrogen produced.

### Experimental Example 2

Analysis of Surface Component of a Platinum Thin Film I (EDX)

An energy dispersion-type X-ray spectroscope (EDX, Hitachi-S4100 model) was used to confirm the component of the platinum thin film prepared in Example 1, and the result was shown in FIG. 3. It was qualitatively confirmed by FIG. 3 that Pt and O were present on the Ni substrate, and chlorine was not detected.

### Experimental Example 3

Analysis of Surface Composition of a Platinum Thin Film II (XPS)

X-ray photoelectron spectroscopy (XPS: XPS-ESCA, PHI-5800 model, excitation energy=1486.6 eV, scan step=0.1 eV) was used to confirm the composition of the platinum thin film prepared according to Example 1, and the result was shown in FIG. 4. Pt peaks and a Ni peak were observed in the XPS spectrum of the platinum thin film in FIG. 4, and the analysis of the Pt peaks shows that Pt (A1 and A2) and Pt oxide (B1 and B2) were present. Information on the composition of the Pt deposit may be obtained from the intensity ratio of the Pt peak, and it may be understood that about 30% of the film surface was a Pt oxide.

### Experimental Example 4

Performance Evaluation I of the Platinum Thin Film Prepared by Example 1

The platinum thin film prepared according to Example 1 of the present invention may be thinly formed. Because platinum particles in the thin film have a microstructure, the film has a wide surface area and the electrical current is thereby increased. Therefore, it is expected that the production of hydrogen may be increased when the Pt thin film is used as a counter electrode for a photoelectrochemical cell.

In order to verify this, a photoelectrochemical cell was used to perform experiments on the reactive activity of hydrogen production of the platinum thin film prepared according to Example 1. The platinum thin film prepared was used as a cathode for a photoelectrochemical cell, and the photoelectrochemical cell was identical to that in the disclosures (KP No. 2006-120791 and US Patent No. 2008/0131762). The silicon cell used has a module efficiency of 17% and a size of 12.5×12.5 cm². The light source was a 1.5 kW xenon lamp and a standard cell (PVM 153, PV measurements, Inc.) was used to adjust the light intensity to 100 mW/cm². 1 M NaOH was used as an electrolyte and a SUS-304 plate was used as an anode. In order to separate hydrogen and oxygen which would be produced, an anion exchange membrane was used. The hydrogen which would be produced was measured by using a wet-test meter (Ritter drum type), and the Solar-to-Hydrogen(STH) efficiency was calculated by the following Formula 1.

$$Solar to Hydrogen Efficiency = \frac{Δ {G}^{o} ( {H}_{2} O ) \times R}{Ir \times A} \qquad [ Formula 1 ]$$

In the Formula 1, ΔG is the Gibbs free energy of formation for 1 mol of liquid water (237.141 kJ/mol), R is the production rate of hydrogen (mol/sec), Ir is the light intensity (W/m²), and A is the area (m²) on which the light is projected.

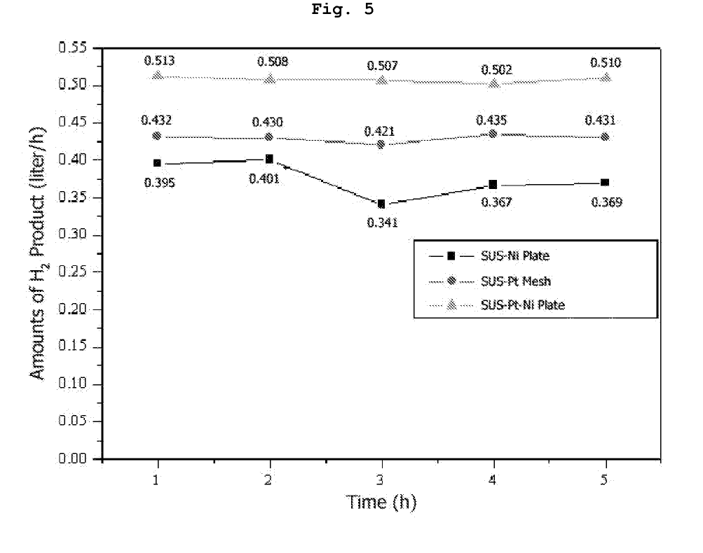

Experimental results are shown in Tables 2 and 3 and FIG. 5. A Ni plate for comparison used a substrate for spraying of a platinum film, and a Pt mesh (pt gauze, 100 mesh fabric Alfa Aesar Co. Ltd., and 99.9% based on metal) was used as a cathode. Table 2 indicates the amount of hydrogen produced which was measured every hour for 5 hours, Table 3 indicates a result which converts the result in Table 2 into the solar to hydrogen efficiency, and FIG. 5 illustrates the results of Table 2.

TABLE 2

| | Rate of H₂ | | | Amount of H₂ | | |
|---|---|---|---|---|---|---|
| | produced (Ml/hr) | | | accumulated (Ml) | | |
| Time | Ni | Pt/Ni | Pt | Ni | Pt/Ni | Pt |
| (h) | plate | plate | mesh | plate | plate | mesh |
| 0 | 0 | 0 | 0 | 0 | 0 | 0 |
| 1 | 395 | 513 | 432 | 395 | 513 | 432 |
| 2 | 401 | 508 | 430 | 796 | 1021 | 862 |
| 3 | 341 | 507 | 421 | 1137 | 1528 | 1283 |
| 4 | 367 | 502 | 435 | 1504 | 2030 | 1718 |
| 5 | 369 | 510 | 431 | 1873 | 2540 | 2149 |

TABLE 3

| | | H₂ pro- | | | | |
|---|---|---|---|---|---|---|
| | ΔG° | duction | | | | Effi- |
| | (H₂O) | rate | R(H₂) | A | Ir | ciency |
| cathode | (kJ/mol) | (l/hr) | (mol/s) | (m²) | (W/m²) | (%) |
| Ni | 237.141 | 0.395 | 4.90 × 10⁻⁶ | 0.014825 | 1000 | 7.8 |
| plate | | | | | | |
| Pt/Ni | 237.141 | 0.513 | 6.36 × 10⁻⁶ | 0.014825 | 1000 | 10.2 |
| plate | | | | | | |
| Pt mesh | 237.141 | 0.432 | 5.36 × 10⁻⁶ | 0.014825 | 1000 | 8.6 |

It may be understood through the results in Tables 2 and 3 that a platinum thin film prepared according to the present invention has a high hydrogen production activity when used as a cathode for a photoelectrochemical cell.

### Experimental Example 5

Performance Evaluation II of the Platinum Thin Film Prepared by Example 1

The performance of Pt thin film was evaluated through the same method as experimental example 4 except that KOH was used as an electrolyte. Experimental results are shown in Tables 4 comparing with experimental example 4. It may be understood through the results in Tables 4, the amounts of hydrogen produced by using platinum thin film was increased and the sunlight-hydrogen efficiency was increased to 10.7%.

TABLE 4

| | | H₂ | | | | |
|---|---|---|---|---|---|---|
| | | production | | | | |
| | ΔG°(H₂O) | rate | R(H₂) | A | Ir | |
| electrolyte | (kJ/mol) | (l/hr) | (mol/s) | (m²) | (W/m²) | Efficiency (%) |
| KOH | 237.141 | 0.541 | 6.71 × 10⁻⁶ | 0.014825 | 1,000 | 10.7 |
| NaOH | 237.141 | 0.513 | 6.36 × 10⁻⁶ | 0.014825 | 1,000 | 10.2 |

What is claimed:

1. A method for preparing platinum thin film using electrospray deposition, including:
dissolving a platinum (Pt) precursor in ethanol to prepare a precursor solution for spraying (Step 1);
applying a DC voltage between a substrate holder and a nozzle of an electrospraying device and then spraying the precursor solution prepared in Step 1 on a substrate which is maintained at 100° C. to 180° C. to form a platinum thin film (Step 2); and
subjecting the platinum thin film formed in Step 2 to a heat treatment (Step 3).

2. The method according to claim 1, wherein a platinum (Pt) precursor in the step 1 is one selected from the group consisting of K₂PtCl₆, hydrogen hexachloroplatinate (IV) (H₂PtCl₆), hydrogen hexachloroplatinate (IV) hydrate (H₂PtCl₆.x(H₂O)), platinum (II) acetylacetonate (C₁₀H₁₄O₄Pt), and tetraamineplatinum (II) nitrate (H₁₂N₆O₆Pt).

3. The method according to claim 1, wherein the concentration of the platinum (Pt) precursor in step 1 is 0.005 to 0.015 M.

4. The method according to claim 1, wherein the temperature of the substrate in step 2 is maintained at 100° C. to 180° C.

5. The method according to claim 1, wherein the substrate in step has a high electrical conductivity and is not reactive to electrolytes.

6. The method according to claim 1, wherein the said substrate is one selected from the group consisting of nickel (Ni), stainless steel (SS), titanium (Ti), copper (Cu), aluminum (Al), molybdenum (Mo), cadmium (Cd), gold, and carbon.

7. The method according to claim 1, wherein the said substrate is nickel (Ni) or stainless steel (SS).

8. The method according to claim 1, wherein the voltage applied between the nozzle and the metal substrate in step 2 is 10 kV to 16 kV.

9. The method according to claim 1, wherein the rate of spraying the precursor solution in step 2 is 10 μl/min to 25 μl/min.

10. The method according to claim 1, wherein the amount of the precursor solution in step 2 is 2 Ml to 5 Ml.

11. The method according to claim 1, wherein the heat treatment in step 3 is performed in a furnace in the range of 350° C. to 450° C. for 1 to 3 hours.

12. A platinum thin film prepared according to claim 1.

13. The platinum thin film according to claim 12, wherein a part of platinum is in the oxidized state on the surface of the thin film after subjecting to the heat treatment in the range of 350° C. to 450° C.

14. The platinum thin film according to claim 12, wherein the platinum in the platinum thin film is arranged vertically to the surface of the substrate.

15. The platinum thin film according to claim 12, wherein the thickness of the platinum thin film is 300 Å to 400 Å.

16. The platinum thin film according to claim 12, wherein the diameters of the platinum particles in the platinum thin film are 100 nm or less.
